(19) United States
(12) Patent Application Publication
(10) Pub. No.: US 2003/0126913 A1
(43) Pub. Date: Jul. 10, 2003

(54) Management equipment and method for hydraulic contents

(76) Inventor: Carlos Alberto Spengler, Sao Paulo (BR)

Correspondence Address: SHAPIRO COHEN, P.O. BOX 3440, STATION D, OTTAWA, ON, K1P6P1, CA

(21) Appl. No.: 10/334,970

(22) Filed: Jan. 2, 2003

(30) Foreign Application Priority Data
Jan. 8, 2002 (BR) PI 0200079-2

(51) Int. Cl. G01M 3/02; G01M 15/00

(52) U.S. Cl. 73/49.7; 73/40

(57) ABSTRACT

Which is constituted of cylinder (1), with liquid inlet nozzle (2), and head (3), where the handling valves are installed, this cylinder and this head, being joined by a support column (4) in which interior are disposed the connection hoses (5) of the internal system and having externally the pressurization inlet (6) to coupling of the compressed air hose, the pressurization valve (7) of the cylinder and the drain exhaust (8), and having also laterally to the cylinder (1) the sight (19) to the control of the liquid level in the cylinder and superior to the head, the control panel (3a) containing the manometer of the cylinder of 4 bar (9), the manometer of 2 bar (10), the additive+water inlet valve (11), the impurity exhaust valve (12), the air inlet (13), the by-pass valve (14), the piped water inlet (15), the piped water valve (16), the sight of impurity exhaust (17) and the sight of the additive+water inlet (18).

The present patent concerns about Invention of MANAGEMENT EQUIPMENT AND METHOD FOR HYDRAULIC CONTENTS, in order to be used in the diagnosis of the cooling system of engines, as well as to carry out the maintenance and replacement of its cooling liquid, being constituted of an equipment of great utility and indispensable in automotive centers, workshops, dockyards, companies that use generators and equipment with stationary engines, etc.

This equipment tests the cleanness of radiators of automotive vehicles from any origin, as well as it cleans internally the engine blocks and other elements that demand periodical hydraulic cleaning of maintenance or test, verification of burned head joint and other procedures that will be further listed.

The referred equipment has been projected and developed for specialists in the area of automotive maintenance and cooling systems, having been taken all the precautions in order to be safe, reliable and of simple handling to any level of professional formation.

The equipment, as well as the mechanic and/or electric valves, and also the system operations, such as:

test of water leak of the engine radiator, hot air internal radiator, hoses and engine reservoir;

test of head crack and burned head joint;

test of pressure with analogue and/or digital reading;

complete cleaning of the cooling system, including water pump, valve, etc., storage of the cooling liquid in the radiator and in all the system;

withdrawal of the water, complementation and drainage of the cooling system; and

test of visual outflow of the water pump working,

can be activated, operated, processed and carried out through mechanic/manual process and/or electronically by the electric-mechanic-pneumatic actuator and specific sensors of information collection to the total and complete supervision, using micro-controllers or even digital processors of high performance, for example, personal computers or workstations, being also possible to be supervised through local network, Internet and Ethernet.

In order to have a clear visualization of the MANAGEMENT EQUIPMENT AND METHOD FOR HYDRAULIC CONTENTS in question, illustrations are shown on the appendix, to which are made references to better elucidate the detailed description that follows.

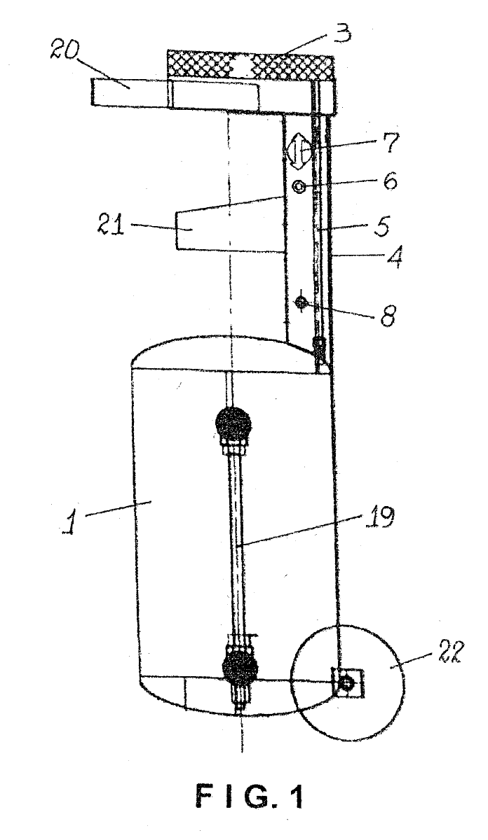

FIG. 1: It represents the lateral view of the head-cylinder set.

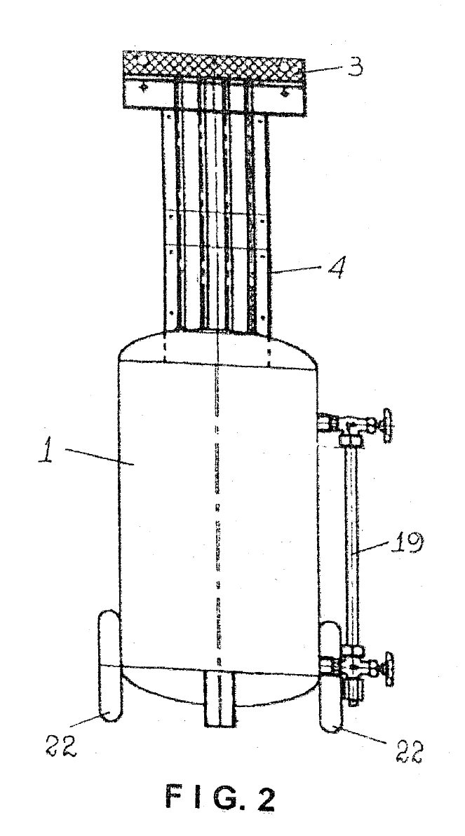

FIG. 2: It represents the frontal view of the head-cylinder set.

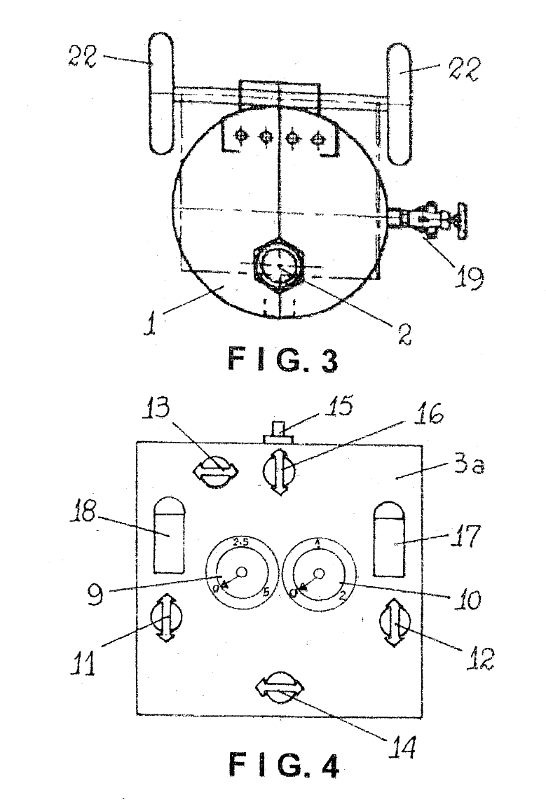

FIG. 3: It represents the upper view of the head-cylinder set.

FIG. 4: It represents in detail the control panel located on the upper part of the head.

According to those illustrations, and in their details, the MANAGEMENT EQUIPMENT AND METHOD FOR HYDRAULIC CONTENTS, proposed herein, is essentially characterized for being constituted of cylinder (1), with liquid inlet nozzle (2), and head (3), where the handling valves are installed, this cylinder and this head, being joined by a support column (4) in whose interior are set the connection hoses (5) of the internal system and having externally the pressurization inlet (6) to coupling of the compressed air hose, the pressurization valve (7) of the cylinder and the drain exhaust (8).

On FIG. 4 it is shown the upper view of the head (3), where it can be seen the control panel (3a) containing the manometer of the cylinder of 4 bar (9), the manometer of 2 bar (10), the additive+water inlet valve (11), the impurity exhaust valve (12), the air inlet (13), the by-pass valve (14), the piped water inlet (15), the piped water valve (16), the impurity exhaust sight (17) and the additive+water inlet sight (18). Laterally to the cylinder (1) it is located the sight (19) to control the liquid level in the cylinder.

The commands of the equipment installed in the head (1) don't need external energy to work, being enough the own work of the vehicle engine.

Moreover, the head (1) has a drawer (20) to transport accessories and, in the support column (4), it is included a tool-compartment element (21).

The test equipment is totally portable, coming with two pneumatic wheels (22).

Procedures to Use the Equipment.

Preparation: Supply the cylinder (1) with the cooling liquid (mono-ethylene glycol) through the inlet nozzle (2), putting 20 liters of ethylene glycol, without surpassing the indicated level on the sight (19) of the cylinder. After closing the inlet nozzle (2), connect a compressed air hose in the pressurization inlet (6). After certifying that all the valves are closed, open the pressurization valve (7) progressively, observing the manometer (9) installed on the panel, which starts to indicate the pressurization of the equipment cylinder. This rate shouldn't surpass 6 bar. If, by accident, this pressure is surpassed, it will start to work automatically a pressure relief valve, followed by a sound signal, and the valve will eliminate the excess of pressure of the cylinder (1). Close the pressurization inlet valve (7) and take off the compressed air hose. On the cylinder sight (19) at a level, select the quantity of liters that will be stored in the vehicle. From this point the equipment is ready to operation, that is, it can be put close and connected to the vehicle to be checked.

Connecting the Equipment to the Vehicle.

The connection of the equipment to the cooling system must be done always with the vehicle engine turned off. The diagnosis, as well as the substitution of the cooling liquid, can be carried out with the system cool or hot. After observing all the safety rules to carry out such operations, open the lid of the expansion reservoir, disconnect the inlet hose of the equipment to the reservoir of water, connect the exhaust hose of the equipment to the return hose of the radiator (the one that was disconnected of the reservoir) using proper adapters. Put the exhaust hose of dirty water drain in a container with appropriate capacity.

Carrying our Diagnoses.

Leak Test.

With the engine turned off, open slowly the inlet air valve (13) of the equipment. Observe the manometer (10) installed on the panel of the equipment to control the pressure that is being injected into the system that shouldn't surpass the mark of 1 bar. After injecting pressure of 1 bar into the system, keep observing the manometer (10) that can indicate possible failures. If the pressure falls, there is the indication of water leak in the system. Verify fortuitous leaks in the engine radiator, in the engine water pump, at the lid of the expansion reservoir, in auxiliary radiators (hot air, accessories, etc.), in passage valves (hot air, accessories, etc.), in hoses, connections, etc., and at the engine seals. In case there aren't visible leaks, verify if the manometer continues with pressure of 1 bar. If so, it means that there is no leak. Otherwise, there can be a crack on the head of the vehicle engine.

Test of the System.

Taking out the pressure, open the by-pass valve (14) and, slowly, the exhaust valve of the equipment. Certifying that there isn't any pressure in the system by the manometer (10) installed on the equipment panel (it must indicate pressure of 0 (zero) bar), close the valves. Open the by-pass valve (14), start the engine and wait till the fan starts to work two times. Accelerate the engine in 3,000 rpm for three minutes. Observe on the manometer (10) if the indicated pressure is not higher than 0.50 bar (half bar) in engines with four cylinders (Remarks: in engines with more than four cylinders, the pressure can reach at most 0.75 bar). If the indicated pressure is higher than 0.50 bar in the engines of four cylinders and 0.75 bar in engines with more than four cylinders, verify the following possible causes (diagnosis):

thermostatic valve locked

switch of the fan

incorrect work of the fan (it doesn't turn on)

return of the radiator to the expansion reservoir obstructed.

After discharged the possibilities above described, in can be inferred that:

the fan turns on but the pressure keeps increasing

the head joint is burned.

Remarks: In case there is no pressure indicated on the manometer (10) after the system be in normal work temperature and being sure that there isn't any leak, it's indication of:

lack of thermostatic valve

possible crack on the head

possible crack on the jacket or block of the engine

improper work of the fan (it doesn't turn off)

air in the system.

In Order to Know if the Head Joint is Burned.

Take out all the pressure of the cooling system of the vehicle through the by-pass valve (14) and equipment exhaust valve. Start up the engine of the vehicle and wait until the fan engine of the vehicle starts to work. Then, verify the value of the manometer pressure that is located on the equipment panel. If it is below 0.50 bar, the system is in perfect conditions. If it's above 0.50 and the temperature of the liquid of the cooling system is normal, in vehicles of four cylinders, this means that the head joint is burned (in the vehicles with more than four cylinders, this mark can not surpass 0.75 bar of pressure).

After the realization of the previous steps, open the by-pass valve (14), start up the engine of the vehicle and wait it reaches the normal temperature of work (to guarantee, wait till the fan starts to work), then close the by-pass valve (14) and open the impurity return valve (12), keeping it totally open, until it's carefully opened the valve of ordinary water storage (16), checking the manometer that is connected in the equipment panel and not permitting that it surpasses the mark of 1 bar of pressure. On this phase, the ordinary water can be seen storing in the vehicle through the tube of the sight (18) on the equipment panel. Next, it can be seen the release of the impurities brought by the liquid through the sight (17).

It must keep visualizing for some minutes the liquid of the impurity exhaust visualization tube (17), comparing it with the liquid of the ordinary water inlet tube (18) till both liquids are with the same color. When they reach the same color, close the ordinary water inlet valve (16) and then open the mono-ethylene glycol inlet valve (11) till store the sufficient to the vehicle.

Test of the Radiator.

With the equipment connected to the cooling system, open the by-pass valve (14), start up the engine and wait till the fan is activated two times. Close the by-pass valve and observe if the manometer (10) installed on the equipment panel is indicating the residual pressure of the system in the moment. Open the exhaust valve (17) to depressurize the system. Observe the manometer (10) that should indicate the depressurized system, that is, 0 (zero) bar.

If the depressurization doesn't happen and the manometer continues indicating residual pressure, or it takes long to indicate 0 (zero) bar, it is indication of blocked radiator.

Carrying Out the Cleaning of the Cooling System.

After carrying out the diagnosis in the cooling system and taking advantage that the equipment is connected to the vehicle, the cleaning and the replacement of the cooling liquid is a simple, quick, safety, and clean operation, just follow the instructions below:

Cleaning the Cooling System.

Connect a piped water hose in the inlet of the (15) equipment, open the exhaust valve (12) and the inlet valve (16) progressively, controlling the pressure according to observation of the manometer (10), that shouldn't surpass the mark of 1 bar. The dirty liquid will be leaving by the sight (17) installed on the equipment panel.

Removing the Expansion Reservoir.

Close the inlet valve (16) and open the exhaust valve (12) and, slowly, the pressurization valve (13), observing that the pressure on the manometer (10) doesn't surpass 1 bar. The pressurization will expel all the water of the expansion reservoir. After removing the cooling liquid, remove the expansion reservoir to cleaning or replacement, if necessary.

Replacing the Cooling Liquid.

Supplying the System with the Cooling Liquid.

Close all the valves of the equipment and open the lid of the expansion reservoir and, slowly, the inlet valve of piped water (ordinary water) (16) of the equipment, observing the level of the cooling liquid in the expansion reservoir. When reaching the recommended level, close the inlet valve and the lid of the expansion reservoir and, then, open the exhaust valve of the equipment and the inlet valve of piped water (16).

Carrying Out the Replacement of the Cooling Liquid.

Open the by-pass valve (14) and start up the engine, when the cooling liquid starts to circle in the system, being possible to be observed circulating in the expansion reservoir. Wait till the fan is activated two times. Close the by-pass valve (14) and open the exhaust valve (12). Open slowly the inlet valve of the piped water (ordinary water) (16), observing that the pressure indicated on the manometer (10) installed on the equipment panel doesn't surpass 1 bar. Observe on the translucent sight (17), located on the equipment panel, that it will happen the replacement of the cooling liquid. When the water of the sight becomes crystal (clean), the cleaning operation will be complete. Close the piped water valve (16) and, then, open the inlet valve of mono-ethylene glycol (11), visualizing on the sight (20) of the cylinder the level of the liquid that has been selected. When reaching the selected value, close the inlet valve (11) and then the exhaust valve (12). Turn off the engine and take off the equipment.

1) “MANAGEMENT EQUIPMENT AND METHOD FOR HYDRAULIC Contents”, characterized for being constituted of cylinder (1), with nozzle of liquid inlet (2), and head (3), where it is installed the handling valves, this cylinder and this head, being joined by a support column (4) in which interior are disposed the connection hoses (5) of the internal system and having externally the pressurization inlet (6) to coupling of the compressed air hose, the pressurization valve (7) of the cylinder and the drain exhaust (8); and for having located laterally to the cylinder (1) the sight (19) to the control of the liquid level in the cylinder.

2) “MANAGEMENT EQUIPMENT AND METHOD FOR HYDRAULIC CONTENTS”, according to claim 1, characterized for having located on the upper part of the head (3) the control panel (3a), containing the manometer of the cylinder of 4 bar (9), the manometer of 2 bar (10), the additive+water inlet valve (11), the impurity exhaust valve (12), the air inlet (13), the by-pass valve (14), the piped water inlet (15), the piped water valve (16), the sight of impurity exhaust (17) and the sight of additive+water inlet (18).

3) “MANAGEMENT EQUIPMENT AND METHOD FOR HYDRAULIC CONTENTS”, according to claim 1, characterized for the head (1) containing also a drawer (20) to accessory transportation, and for having included in the support column (4) a tool-compartment element (21).

4) “MANAGEMENT EQUIPMENT AND METHOD FOR HYDRAULIC CONTENTS”, according to claim 1, characterized for the test equipment being totally portable, for that being supplied with two pneumatic wheels (22) to locomotion.
